(19) United States
(12) Patent Application Publication
(10) Pub. No.: US 2012/0312511 A1
(43) Pub. Date: Dec. 13, 2012

(54) WATER VAPOR CONTROL OF EMISSIONS FROM LOW QUALITY FUEL COMBUSTION

(76) Inventors: Howard E. PURDUM, Research Triangle Park, NC (US); William L. DOWNS, Pembroke, GA (US); Lawton V. DOWNS, Statesboro, GA (US); Edward R. SECHREST, Greenwood, MO (US); William J. KADRI, Powder Springs, GA (US)

(21) Appl. No.: 13/471,918

(22) Filed: May 15, 2012

Related U.S. Application Data
(60) Provisional application No. 61/486,588, filed on May 16, 2011.

(51) Int. Cl. F28F 7/00; B01D 51/08; F15C 1/00

(52) U.S. Cl. 165/138; 137/803; 95/29

(57) ABSTRACT

Exhaust having particulate matter travels through a condensation chamber. Liquid vapor, such as water vapor, is provided to the condensation chamber. High intensity sound of low, mid-range and high frequencies accelerates the growth and collection of water droplets that contain the target emissions by moving the particles and gases at differing speeds to increase the amount of interaction between droplets and particulates. The result is the rapid growth of droplets entrapping particulates to remove the particulates form the exhaust stream. An acceleration enhancement is the application of opposite electrical charges to the vapor and the emissions. Sound and charging can be used independently, or in combination.

This application claims the benefit of U.S. Provisional Application No. 61/486,588, filed May 16, 2011, the contents of which are incorporated herein by reference.

### FIELD OF THE INVENTION

The present invention relates generally to a method and system for controlling emissions from low quality fuels, primarily coal and biomass. Furthermore, the invention relates to a method and system for capturing emissions in a condensing water vapor environment.

### BACKGROUND

The quality of a fuel depends on the heat and the amount of contaminants contained in the fuel. High quality fuels, such as natural gas, have high heat contents and minimal contaminants. Unfortunately, the supply of these high quality fuels is limited. As these limited supplies decrease, prices rise, and the industrialized countries become increasingly dependent upon supplier countries that are politically unstable.

Lower quality fuels must therefore be used in place of higher quality fuels. The majority of the world's supply of low quality fuel is coal, followed by peat, biomass, and other carbon rich, but highly contaminated fuels. Coal currently accounts for about half of the electrical power generated in the United States. China is building one new coal powered plant per week. India and other developing countries are also rapidly expanding their coal use. A strong global need therefore exists for technologies that can burn coal, but without excessive environmental damage.

A major environmental problem in using low quality fuels is the release of particulate matter during combustion. The original pollution control techniques for coal combustion focused on soot, which forms black clouds of smoke. Improved combustion processes have greatly diminished the appearance of soot plumes. Nevertheless, modern power plants still emit some soot. Furthermore, even the best combustion systems also emit small ash particles.

Modern power plants also emit gas phase pollutants, notably nitrogen and sulfur oxides (NOx and SOx). These gases form nitric and sulfuric acids, respectively, which are the most damaging components of acid rain. In addition, NOx and SOx eventually form microscopic particles that are commonly seen as smog. To control these emissions, government agencies have applied increasingly strict environmental regulations.

Beginning with particulate emissions, the simplest approach to meeting these regulations is the use of a fabric filter. Groups of these filters are assembled in a “baghouse,” which is located downstream of the combustor. As the exhaust gas passes through the baghouse, the particulates are trapped in the filter media. The problem with this approach is that the capture of fine particles requires a large surface area of tightly woven fabric. Fabric filters are therefore economical only for the capture of relatively large particulates.

To capture smaller particulates, the most common technique is the electrostatic precipitator, or ESP. The first step in this process is to apply an electrical charge to the particles. The charged particles are then attracted to an oppositely charged plate, and are thus removed from the exhaust stream. One limitation of ESP systems is that they are expensive to buy and operate. Another limitation is that electrostatic precipitators become progressively less effective as the particle size decreases. Specifically, ESP's are fairly effective in meeting Environmental Protection Agency (EPA) PM10 requirements, which state that particle collection must be effective to particles with a diameter greater than 10 microns.

The latest EPA rules, however, require control down to particles with a diameter of 2.5 microns, or PM2.5. The medical reason for this standard is that PM10 particles can be trapped in the upper respiratory tract and then expelled from the body, but PM2.5 particles can pass the body's upper respiratory defenses and proceed to the lung. Once in the lung, these particles cannot be expelled from the body, and can even proceed to other internal organs. Furthermore, because these particles have a relatively high surface area, they can be quite reactive in the body. Small particulates may thus cause multiple diseases, ranging from lung ailments such as asthma, to cardiac and nervous disorders.

Because ESP systems cannot economically meet PM2.5 standards, some alternative technology is therefore necessary. One such alternative is to use sound waves instead of electrostatic force to remove the particles from the exhaust stream. The underlying physical principle is that sound waves exert acoustic radiation force on a particle in a gas stream. Because the resulting forward displacement is less than the subsequent reverse displacement, the net result is a forward motion in the direction of the propagating sound wave. The most useful frequencies for particle displacement are in the low kHz range (2 to 5 kHz). Conversely, frequencies in the upper tens of kHz move the gas past the particle because of inertia, thus leaving the particle essentially in the same place and therefore not achieving the desired displacement. In practice, however, acoustic separation systems have been found to be more expensive than ESP systems, despite the latest technical developments in sound generating equipment. Acoustic systems are therefore not now in commercial use. More importantly, sound waves do not efficiently move a large number of particles any appreciable distance to a collection device, such as a filter.

The use of sound waves to clear fog from cold water ports has been attempted in Russia. This provides the mathematical basis for condensation growth on a particle in a sonic field. This technique is not practical in clearing ports due to the excessively high noise levels.

Another alternative is to surround the particles with a condensing environment. As the humidity progresses from supersaturated down to saturated conditions, a layer of water condenses on the surface of the suspended particles. The wetted particles can then be trapped by a variety of techniques.

One such technique is simply to mimic a rainstorm inside the exhaust stack. In this approach, the droplets form on the particulates in the same manner as rain droplets form on dust in clouds. Also like rain, the droplets fall out of the exhaust stream once they have reached sufficient size. Although simple in principle, this technique has not proven to be economical in practice. The main problem is the large size, and thus high cost, of the required equipment.

A variant of this basic condensation process is the wet electrostatic precipitator (wESP). In this device, a conventional ESP is modified to work in a condensing environment; the underlying principle of attraction of charged emissions to a collector remains. While promising, this emerging technology has immense technical limitations because of the use of high voltages in a wet environment.

Another version of a charged condensing system consists of applying the opposing charge to the condensing steam, instead of a collection plate. Under this approach, the particles and steam are thus attracted to each other, and therefore the condensation layer grows more quickly than it would under normal conditions. The limitation in this process is the difficulty of producing the optimum size and charge for the condensing steam droplets. Although an early version claims to be significantly less costly than an ESP, this technology has not proven to be economical in the field.

After particulates, the remaining regulatory concern is acid gases. For acid gas emissions, fabric filters and ESP units are ineffective. The most common acid gas control utilizes limestone or other absorbers to trap SOx, and ammonia injection or catalysts to control NOx. Both procedures are quite expensive, and still leave residual, highly corrosive acids in the exhaust stream. All of the above condensation processes share the ability to dilute and/or capture acid gases to some degree, but none has proven to be successful commercially.

Depending on the specific plant and the type of coal, several different techniques are then used to clean the exhaust stream. For example, some sites employ mercury capture and selective catalytic reduction (SCR) for NOx control, but other sites do not use this equipment. Likewise, some sites use cyclones, baghouses, or ESP's for particulate control, but other sites do not. Regardless of the specific equipment at a given site, all exhaust leaving conventional emission control systems still contains large numbers of small particles that do not meet PM2.5 standards, along with significant amounts of acid gases.

First, conventional sonic systems are dry, not condensing. The sound waves in conventional systems must therefore drive the particles across the entire treatment volume. Driving particles across such large distances, however, is a time-consuming, difficult task, particularly for small particles. To overcome this problem, sound is used in conjunction with droplets so that particles due not travel far without encountering a droplet. Droplets quickly grow in size and condense, taken the particles as they drop out of suspension.

A need therefore exists for an effective, economical means and method of controlling the particulate and acid gas emissions from the combustion of low quality fuels. Condensing systems are capable of addressing both types of emissions, and are therefore the preferred approach in this invention. Significant barriers remain, however, in making condensation systems practical in terms of particle collection, acid gas capture, equipment cost, and operating expense.

It is an object of the invention to provide a condensation chamber capable of efficiently removing particulate matter and other pollutants form an exhaust stream.

It is another object of the invention to have a condensation chamber supplied with liquid droplets and soundwaves to increase collisions between droplets and the particulate matter.

It is yet another object of the invention to provide a condensation chamber that can be added to existing power plants.

It is still another object of the invention to provide a condensation chamber the removes pollutants form an exhaust stream in an efficient and affordable manner.

These and objects of the invention will be apparent to one of ordinary skill in the art after reading the disclosure of the invention.

### SUMMARY OF THE INVENTION

A method and apparatus controls the emissions from the combustion of low quality fuels, such as coal and biomass. The underlying principle is condensing water vapor traps particulates and dilutes or traps acid gases. Exhaust having particulate matter travels through a condensation chamber. Liquid vapor, such as water vapor, is provided to the condensation chamber. High intensity sound of low, mid-range and high frequencies accelerates the growth and collection of water droplets that contain the target emissions by moving the particles and gases at differing speeds to increase the amount of interaction between droplets and particulates. The result is the rapid growth of droplets entrapping particulates to remove the particulates form the exhaust stream. An acceleration enhancement is the application of opposite electrical charges to the vapor and the emissions. Sound and charging can be used independently, or in combination.

### BRIEF DESCRIPTION OF THE DRAWINGS

FIG. 1 is a schematic diagram of the complete power system according to one exemplary embodiment;

FIG. 2 illustrates an exemplary embodiment for use in trapping particles and gases; and

FIG. 3 is a schematic top view of a condensation chamber.

### DETAILED DESCRIPTION OF THE INVENTION

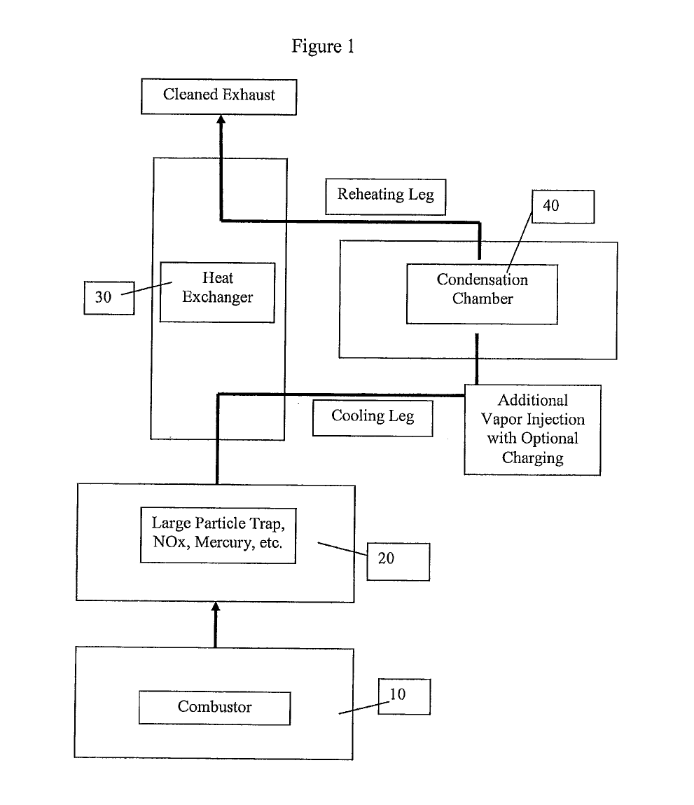

Referring now to the drawings, FIG. 1 illustrates an exemplary power system. Coal is burned in the combustor 10. The released heat generates steam to power the turbine, thus producing electrical power. The emissions include soot, unburned hydrocarbons, ash, NOx, SOx, and all naturally occurring elements, notably toxic mercury and selenium. The exhaust first travels through a gas reactor 20. A suitable substance, such as limestone, reacts with SOx to capture this gas. Other devices, such as SCR for NOx and additives for mercury, as described above, are added as necessary for specific plant designs and coal types.

In addition to, or in replacement of, these devices, the new technology uses the following condensation approach.

The first step is to lower the temperature of the exhaust stream so that steam can condense as water vapor. One conventional means of achieving this temperature reduction is the placement of a heat exchanger 30 upstream of the condensation chamber. In particular, the heat exchanger 30 is arranged so that the extracted heat is available to re-warm the treated gas from the condensation chamber. The benefit of this approach is that the exhaust is sufficiently reheated to flow up through the exhaust stack and be dispersed; otherwise, the exhaust would form an undesirable “fog” around the base of the power plant.

The main limitation of the heat exchanger approach is that while the combustion of any hydrocarbon fuel produces some steam that can be used for a condensation trap, the amount of steam depends on the fuel chemistry, specifically the hydrogen that burns to form water. Unfortunately, many fuels do not have enough hydrogen content to produce adequate amounts of steam.

For this reason, condensing systems often add additional steam. One source of this additional steam is a boiler, which produces both waste heat and waste steam. Another source of additional steam is the injection of water into the exhaust stream, which has the additional benefit of cooling the exhaust. Water vapor can also be supplied to the condensation chamber by any suitable means, such as nozzles embedded in the chamber sidewall or added to the exhaust stream before entering the condensation chamber.

At this point, the exhaust is sufficiently cool and contains sufficient steam. This prepared exhaust then enters the condensation chamber 40, where the nucleation and droplet growth occurs, along with treatment of acid gases.

These processes continue throughout the length of the condensation chamber, with heat continuously removed through the chamber walls. The condensation products are trapped at the base of the chamber, where they can be filtered, chemically neutralized, or processed by other suitable techniques as desired. After the condensation products have thus been removed, the treated exhaust stream is either allowed to dissipate, or reheated in the heat exchanger 30 to exit through the exhaust stack.

Because simple condensation systems alone do not provide adequate treatment of either particulates or acid gases, some means of augmenting the basic processes are necessary. These modifications are best performed within the condensation chamber 40.

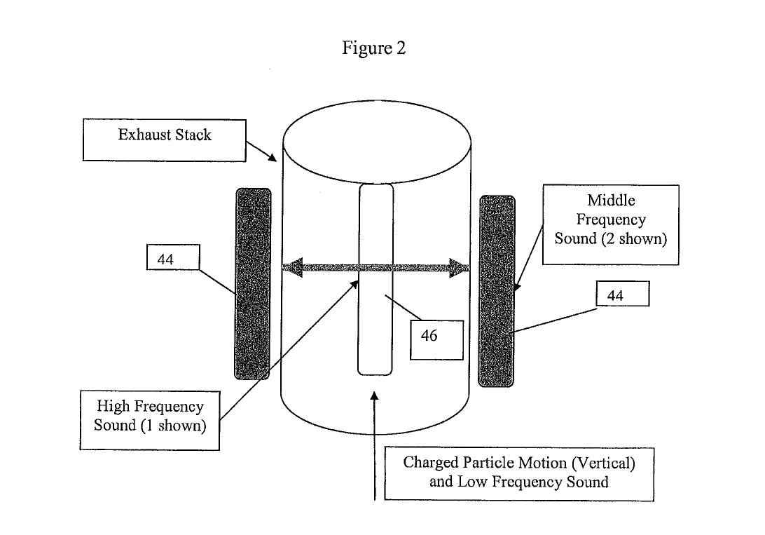

FIG. 2 depicts a condensation chamber with a sonic system and a charged particle system. The sonic system uses high intensity sound to move the particles and gases inside the condensation chamber. The particles move short distances. This short motion produces two results. First, particles may impact each other, and thus become large enough to fall out of the system. Because sound waves move particles of different sizes at different speeds, sound induces much more collisions than occur in conventional systems. Second, the particles may move into a new zone of relatively higher humidity, and thus grow more quickly than conventional particles that are locally diffusion limited.

The system utilizes lower frequencies, specifically in the few hundred Hz range that may be generated by any suitable frequency generator. This frequency range is known to be quite effective in stabilizing fuel combustion, so this equipment is commercially available. In addition, this frequency is in the same range as the dominant frequency of the “rappers” used to clean conventional ESP units. Similar to the “rappers” in an ESP system, the low frequency sound is effective in moving the collected sludge through the condensation chamber. High intensity, low frequency sound also improves heat transfer at the walls due to disruption of the boundary layer, thereby aiding thermophoresis particle capture, and induces bulk mixing of both the particles and gases in the chamber, thus improving overall system effectiveness.

Mid-range frequency sounds, in the range of two to five kHz, move particles across short distances. The particles do not have to move very far before encountering a vapor droplet. The resulting increased number of collisions between particles and vapor droplets removes the particles from the exhaust stream, as the vapor droplets quickly grow in size and fall out of suspension.

Higher frequencies, in the range of about 15 to 20 kHz, are also employed in the system. Unlike lower frequencies (2 to 5 kHz) that move the particles in the gas, frequencies in the upper teens of kHz move the gas past the particles. In conventional particle collection systems, these higher frequencies are thus of no use because they do not move the particles nearer to the collection zones. In the current system, however, the ability to move the vapor past the particles provides the opportunity for much more rapid condensation.

The net result is that different frequencies produce different effects in the condensing system, unlike the single frequency systems previously disclosed. Specifically, in the new system, the frequencies are (1) hundreds of Hz for bulk mixing action and for transfer of both heat and mass, (2) low kHz for moving the particles within the gas to increase condensation, increase particle to particle collision, and to increase particle collision with the collecting surfaces, and (3) high frequency sound to improve vapor condensation on the particles. These frequency dependent effects occur independently, and can thus be applied in combination.

For maximum effectiveness, the waves should be orthogonal to achieve maximum growth. Sound is also best applied under resonance conditions. Sound propagation varies with temperature; the frequency is adjusted to keep the system at maximum effectiveness at all temperatures. The existing power plant equipment is large and highly sound absorbing, so sound is applied at opposing edges. The frequency generators face each other. The opposing speakers are phase shifted so that a positive wave from one speaker encounters a negative wave from the opposed speaker. This approach provides maximum, uniform treatment throughout the entire gas volume.

Both standing and traveling waves can be used. Traveling waves treat the whole volume, not just the antinodes (leaving the nodes essentially untouched) of standing wave systems. Mixed frequencies work particularly well with traveling waves.

Because maximum relative particle motion yields maximum particle condensation growth, and thus maximum collection effectiveness, a combination of frequencies is used, as illustrated in FIG. 2. In this case, the lowest frequencies, only a few hundred Hertz, are directed along the flow axis by an in-line frequency generator. The middle and high frequencies are oriented at right angles to the low frequency sound, and to each other. This orthogonal geometry thus provides maximum exposure of the particle to the vapor at all points in the condensation chamber.

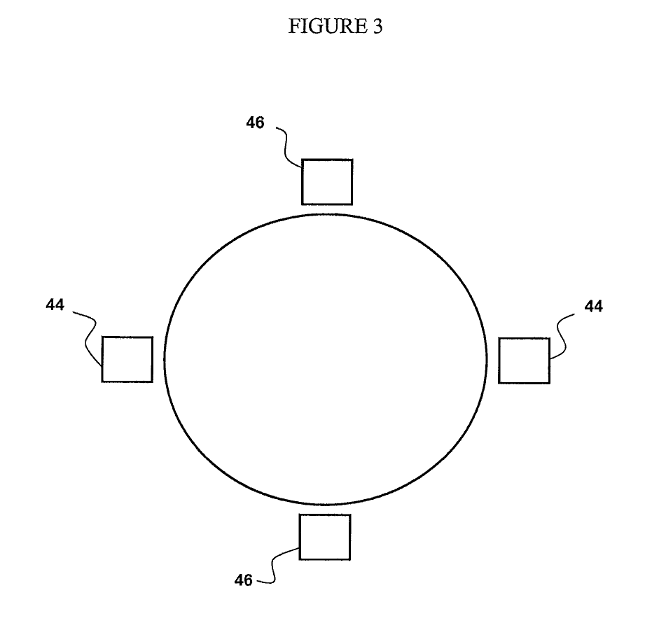

FIG. 3 depicts the arrangement of frequency generators relative to the condensation chamber. The chamber is surrounded by a pair of diametrically opposed medium frequency (2-5 kHz) frequency generators 44 and a second pair of diametrically opposed higher frequency (15-20 kHz) frequency generators 46. The frequency generators are located outside of the condensation chamber but connected to the chamber interior by waveguides, such as a cylindrical or conical structure. The end of the waveguide may be coincident with the chamber sidewall or extend into the chamber. The sound waves from the frequency generators prevent emissions from escaping through the ports created by the wave guides. In this manner, the frequency generators are protected from the emissions.

The frequency generators need not be provided in pairs, as a single speaker will provide beneficial results, especially in smaller systems. In addition, the pair need not be diametrically opposed to one another and the two pairs need not be orthogonal to one another. It is possible to have a single midrange frequency generator separated from a single high frequency generator by more or less than ninety degrees. In addition, each of the three frequency generators can be used alone or in combination. A system need not have low, midrange and high frequency generators. The application of sonic energy to the exhaust stream introduced into the condensation chamber enhances the entrapment of particles by the vapor droplets. A system having only one or two of the three types of frequencies will have beneficial results as compared to a system not employing the use of sound generators.

A broad range of droplet sizes can be created with any suitable steam/mist generator, and any simple charging device. The resulting charged spray is therefore cheap to make and maintain. Specifically, as noted above, particles of different sizes move at different speeds under sonic exposure. This variability of motion, along with variability in charge, thus again induces more collisions, and therefore better collection, than would otherwise occur.

The system generates mist. The largest mist particles spontaneously fall, but the use of a demisting device greatly improves overall capture. Multiple means of mist capture are already known, and each can be applied to catch particles and dissolved gases here. Examples of demisting devices include screens, rotating blades, venturi systems, etc. The major optional enhancement is electrical charging of these known units under the charged particle option.

Charged steam is more effective than non-charged steam. The combustor creates slag and quenching the combustor's slag in water produces massive amounts of charged steam which can be used for the entrainment of particles. For non-slagging systems, charged steam can be created using conventional steam generators.

The system can (1) enhance capture of mercury vapor on activated particles, (2) improve limestone particle capture of SOx in a scrubber, (3) improve combustion efficiency by using the same frequencies mentioned above. Combustion efficiency is improved by the use of frequency generators in the combustor 10. The sound waves move hot gas across burning fuel particles, thus increasing the speed and effectiveness of combustion, burning out the combustible fractions, and leaving ash for subsequent capture. The first and second applications pertain to the gas reactor, or scrubber 20. In these applications, the particles are limestone or activated carbon, with the sound waves moving these particles short distances to increase reactions with SOx and mercury, respectively. The larger particles produced by these reactions can be removed by ESP, driven to the walls with the lowest frequency, while the smallest particles are removed in the vapor trap 40.

In one example, a small scale system was assembled using a standard home size cast iron unit as the combustor with a standard shop vacuum providing combustion air. A Y connection for the exhaust allowed the addition of steam from a propane fired boiler and a heat exchanger lowered the exhaust to 100° C. A second heat exchanger downstream of the Y connection was provided with ports for the mounting of automotive audio speakers. The speakers provided frequencies in all three ranges. Microscope slides with surface adhesive were mounted upstream and downstream of the heat exchanger. West Virginia bituminous coal was used as the fuel with 5 kg burned to a complete red glow before an additional 5 kg of coal was added.

Without sound, the emissions consisted of clouds of wet soot and ash, but the application of sound produced a steady stream of soot and ash sludge at the bottom of the second heat exchanger, acting as the vapor trap. Other observation included the increase of power to the speakers with little or no effect until a threshold was reached, after which there were immediate strong effects. After the threshold, additional power again produced only limited gains. Also, the applied sound caused a rapid progression of a condensation band along the heat exchanger volume. A sound absorbing fiber mesh controls the onset of condensation. Comprised of inert fiber, this mesh prevents the onset of condensation upstream of the condensation chamber, thereby ensuring that the condensation occurs in a stable fashion, and where means are available to collect the products. The addition of steam inlets along the length of the vapor trap maintained the temperature and adequate concentrations of steam. Comparisons of the microscope slides showed greater than 99% capture of soot and ash.

In the most general sense, this approach applies to any system in which particles react with surrounding vapors or gases. This is a huge range of potential applications in chemical engineering, food processing, etc.

We claim:

1. A condensation chamber comprising
a chamber having a sidewall;
at least one frequency generator emitting a first frequency into the chamber; and
a source of vapor.

2. The condensation chamber of claim 1, wherein the at least one frequency generator is a pair of frequency generators producing the first frequency.

3. The condensation chamber of claim 2, further comprising a second pair of frequency generators producing a second frequency different than the first frequency.

4. The condensation chamber of claim 3, wherein the second frequency is higher than the first frequency.

5. The condensation chamber of claim 3, further comprising a third pair of frequency generators producing a third frequency, the third frequency being lower than the first frequency.

6. The condensation chamber of claim 1, further comprising a waveguide connecting the at least one frequency generator to an interior of the chamber.

7. The condensation chamber of claim 1, further comprising a charging device applying opposite charges to the vapor and particles in the chamber.

8. A method of removing pollutants, comprising
providing an exhaust stream to a chamber, the exhaust stream having particles;
supplying vapor to the stream; and
applying sound waves to the stream in the chamber.

9. The method of claim 8, further comprising:
cooling the exhaust stream to convert steam into water vapor.

10. The method of claim 8, further comprising:
supplying water vapor by converting steam to water vapor.

11. The method of claim 8, wherein applying sound waves comprises applying sound waves of a first frequency to diametrically opposed positions of the chamber.

12. The method of claim 11, wherein applying sound waves further comprises applying sound waves of a second frequency to diametrically opposed positions of the chamber, the second frequency being higher than the first frequency.

13. The method of claim 8, further comprising:
applying opposite charges to the water vapor and particles

14. A power plant, comprising:
a condensation chamber having a sidewall,
at least one pair of frequency generators emitting a first frequency into the condensation chamber; and
a heat exchanger cooling an exhaust stream to convert steam into water vapor.

15. The power plant of claim 14, further comprising a second pair of frequency generators producing a second frequency different than the first frequency.

16. The power plant of claim 15, wherein the second frequency is higher than the first frequency.

17. The power plant of claim 15, further comprising a third pair of frequency generators producing a third frequency, the third frequency being lower than the first frequency.

18. The power plant of claim 14, further comprising a waveguide connecting the at least one frequency generator to an interior of the chamber.

19. The power plant of claim 12, further comprising a charging device applying opposite charges to the water vapor.
